(19) United States
(12) Patent Application Publication
(10) Pub. No.: US 2025/0385026 A1
(43) Pub. Date: Dec. 18, 2025

(54) STRAIN RELIEF GROMMET

(71) Applicant: ACLARA TECHNOLOGIES LLC, St. Louis, MO (US)

(72) Inventor: Christopher Andrew Porter, Weare, NH (US)

(21) Appl. No.: 18/874,805

(22) PCT Filed: Jun. 16, 2023
(86) PCT No.: PCT/US2023/068556

§ 371 Date: Dec. 13, 2024

Related U.S. Application Data
(60) Provisional application No. 63/353,321, filed on Jun. 17, 2022.

(51) Int. Cl. H01B 17/58; H02G 1/08

(52) U.S. Cl. CPC H01B 17/586; H02G 1/08

(57) ABSTRACT

A strain relief grommet is disclosed. The strain relief grommet comprises a bulkhead grommet including an inner wall abutting portion, an outer wall abutting portion, a groove portion having an axial portion extending between the inner wall abutting portion and the outer wall abutting portion, and a grommet inner aperture extending through the axial portion of the groove portion. A strain relief feature is connected to the bulkhead grommet.

### PRIORITY CLAIM

The present application claims the benefit of priority of U.S. Provisional Patent Application Ser. No. 63/353,321, titled “Strain Relief Grommet,” filed Jun. 17, 2022, which is incorporated herein by reference in its entirety.

### FIELD

Grommets and strain relievers may be used to protect electrical cables during use.

### SUMMARY

According to one embodiment, a strain relief grommet is described. The strain relief grommet may comprise a bulkhead grommet including an inner wall abutting portion, an outer wall abutting portion, a groove portion having an axial portion extending between the inner wall abutting portion and the outer wall abutting portion, and a grommet inner aperture extending through the axial portion of the groove portion. A strain relief feature may be connected to the bulkhead grommet.

According to another embodiment, an electrical enclosure is described. The electrical enclosure may include an enclosure housing including a bulkhead. A bulkhead grommet may be installed in the bulkhead. The bulkhead grommet may include an inner wall abutting portion, an outer wall abutting portion, a groove portion having an axial portion extending between the inner wall abutting portion and the outer wall abutting portion, and a grommet inner aperture extending through the axial portion of the groove portion. A strain relief feature may be connected to the bulkhead grommet.

According to another embodiment, a method of installing a strain relief grommet is described. The method may include pressing a cable through a gap portion in a bulkhead grommet and into an inner aperture of a bulkhead grommet of the strain relief grommet; and guiding the cable through a strain relief feature of the strain relief grommet.

Other aspects of the technology will become apparent by consideration of the detailed description and accompanying drawings.

### BRIEF DESCRIPTION OF THE DRAWINGS

FIG. 1 is an example of a perspective view of a strain relief grommet.

FIG. 2 is an example of a sectional view of a strain relief grommet with a connectorized cable fit therein.

FIG. 3 is a view of an example of a strain relief grommet installed in a bulkhead of an enclosure.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. As used within this document, the word “or” may mean inclusive or. As a non-limiting example, if examples in this document state that “item Z may comprise element A or B,” this may be interpreted to disclose an item Z comprising only element A, an item Z comprising only element B, as well as an item Z comprising elements A and B.

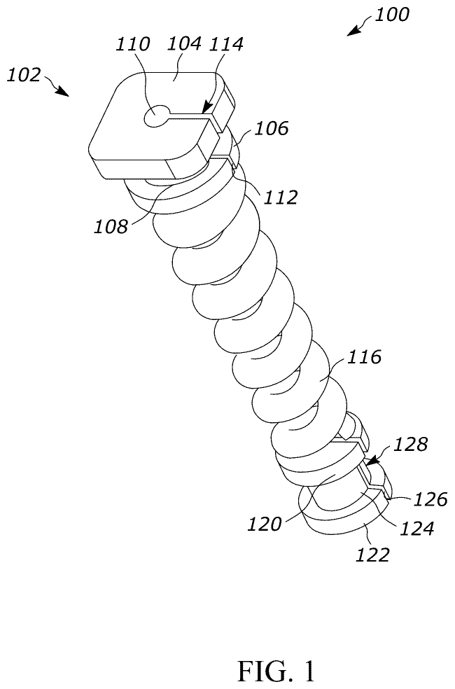

FIG. 1 illustrates an example strain relief grommet 100. The strain relief grommet 100 includes a grommet 102 configured to be inserted through a bulkhead in surface (e.g., a bulkhead in a wall of a structure, a bulkhead in a surface of a housing of an enclosure). In the embodiment shown, the grommet 102 includes both an inner wall abutting portion 104 and an outer wall abutting portion 106. However, in some cases, the grommet 102 only includes the inner wall abutting portion 104. In some cases, the inner wall abutting portion 104 and the outer wall abutting portion 106 may be of different sizes or shapes. For example, the inner wall abutting portion 104 may be generally square shaped, and the outer wall abutting portion 106 may be circular in shape, or vice versa. The grommet 102 may be formed of a flexible, or collapsible material. For example, the grommet 102 may be formed from foam or rubber. The inner wall abutting portion 104 of the grommet 102 may be configured to flex, constrict, or collapse as it is inserted into a bulkhead (e.g., by pushing the grommet 102 through the bulkhead using a finger or a tool). The grommet 102 may include a groove portion 108 extending between the inner wall abutting portion 104 and the outer wall abutting portion 106. The groove portion 108 may also be configured to flex, constrict, or collapse as it is inserted into the bulkhead, but in some cases the groove portion 108 may be rigid. The inner wall abutting portion 104 of the grommet 102 may be configured to return to its original shape (e.g., its unflexed, non-constricted, non-collapsed shape) after it is inserted through the bulkhead. After returning to its original shape, the inner wall abutting portion 104 of the grommet 102 may be configured to prevent itself from being pulled back through the bulkhead. In this way, the inner wall abutting portion 104 of the grommet 102 helps to secure the grommet 102 in the bulkhead.

An inner aperture 110 extends through an axial portion of the groove portion 108 and may be configured to accommodate a cable (not shown). The grommet 102 may include an split or gap portion 112 that forms a gap portion 114 extending from the inner aperture 110 to an outside surface of the grommet 102. The outer wall abutting portion 106 may be configured to abut an outer wall of the bulkhead, thereby causing the groove portion 108 to be retained within the bulkhead, between the inner wall abutting portion 104 and the outer wall abutting portion 106 once inserted.

The groove portion 108 may be smaller in size that the inner wall abutting portion 104 and the outer wall abutting portion 106 and therefore may have a smaller circumference, length, or width. However, in some embodiments, the groove portion 108 may have a greater depth than the inner wall abutting portion 104 or the outer wall abutting portion 106, the depth of the groove portion 108 extending in an axial direction of the groove portion 108. The groove portion 108 may also be made as a flexible or collapsible material (e.g., rubber, foam), but is made of a rigid material in some embodiments (e.g., plastic, hard metal). The groove portion 108 may include the inner aperture 110 configured to accommodate a cable. The inner aperture 110 may be smooth or polished, so as to not snag on a shifting or flexing cable inserted therethrough.

A strain relief feature 116 may be connected to the grommet 102. In the embodiment shown, the strain relief feature 116 is connected to the outer wall abutting portion 106. The strain relief feature 116 may be made of a semi-flexible material configured to bias a cable inserted therethrough toward a straightened configuration. For example, when a cable is pressed through the gap portion 112 of the grommet 102 and inserted into the strain relief feature 116 (e.g., by winding the cable through a spiral-shaped strain relief feature 116), the strain relief feature 116 may be configured to maintain a straightened configuration and bias the cable toward an un-bent configuration as the cable is bent. In the embodiment shown, the strain relief feature 116 is spiral-shaped, but the strain relief feature 116 may also be zig-zag shaped, straight-shaped, arc-shaped, or any other shape that may produce a straightening bias against a cable inserted, guided, or woven therethrough.

In the embodiment shown, a cable centering portion 118 may be connected to an aft end of the strain relief feature 116. In the embodiment shown, the cable centering portion 118 includes both an inner lip portion 120 and an outer lip portion 122. In some cases, the cable centering portion 118 only includes one of the lip portions 120, 122. In other cases, the cable centering portion includes neither of the lip portions 120, 122.

The cable centering portion 118 may be formed of a flexible, or collapsible material. For example, the cable centering portion 118 may be formed from foam or rubber. In some cases, the cable centering portion is made of plastic or metal. The inner lip portion 120 or the outer lip portion 122 may be made of flexible, collapsible material, but may also be made of rigid material (e.g., plastic, metal). An inner aperture (not shown) extends through an axial portion of a groove portion 124 of the cable centering portion 118 and may be configured to accommodate a cable (not shown). The cable centering portion 118 may include an split or gap portion 126 that forms a channel 128 extending from the inner aperture to an outside surface of the cable centering portion 118.

The groove portion 124 may be smaller in size that the inner lip portion 120 and the outer lip portion 122 and therefore may have a smaller circumference, length, or width. However, in some embodiments, the groove portion 124 may have a greater depth than the inner lip portion 120 or the outer lip portion 122, the depth of the groove portion 124 extending in an axial direction of the groove portion 124. The groove portion 124 may also be made as a flexible or collapsible material (e.g., rubber, foam), but is made of a rigid material in some embodiments (e.g., plastic, hard metal). The groove portion 124 may include the inner aperture (not shown) configured to accommodate a cable. The groove portion 124 may be configured to accommodate a cable movement restraint element (not shown) such as a wire tie, a zip tie, a clip, etc. used to pinch the groove portion 124 so that the cable is prevented from slipping forward or backward within the inner aperture (e.g., prevented from being pushed through or pulled through the inner aperture). In some embodiments, the inner aperture is smooth or polished so as to not snag on a shifting or flexing cable inserted therethrough.

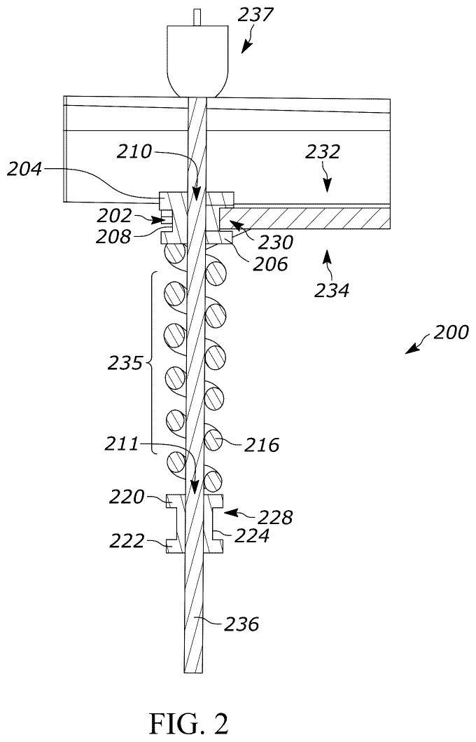

FIG. 2 shows a sectional view of a strain relief grommet 200 inserted into a bulkhead 230 having an inner wall surface 232 and an outer wall surface 234. The bulkhead grommet 202 of the strain relief grommet 200 is retained in the bulkhead 230 by the inner wall abutting portion 204 abutting the inner wall 232 of the bulkhead 230, thereby preventing a removal of the bulkhead grommet 202 from the bulkhead 230. Further, in the embodiment shown, the outer wall abutting portion 206 prevents the bulkhead grommet 202 from being pushed all the way through the bulkhead 230 by abutting the outer wall 234 of the bulkhead 230. The groove portion 208 may also prevent a shifting of the bulkhead grommet 202 when inserted in the bulkhead 230. In the embodiment shown, a connectorized cable 236 (e.g., a cable having an electrical connector attached thereto) has been routed through the bulkhead 230. A non-connectorized portion 235 of the cable 236 is inserted into a strain relief grommet 200 by pressing the non-connectorized portion 235 through the gap portion 114 the grommet 102 and into the inner aperture 210 of the grommet 102. The grommet may then be inserted into the bulkhead 230. The non-connectorized portion 235 of the cable 236 is guided through the spiral-shaped strain relief feature 216 and pressed through a gap portion 126 and into the inner aperture 211 of the cable centering portion 228. In this way, a cable 236 including a connector 237 can be run through the strain relief grommet 200 without needing to disassemble the connectorized cable 236 or remove the connector 237.

The non-connectorized portion 235 of the cable 236, having been inserted into the strain relief grommet 200, is biased by the strain relief feature 216 into a straightened configuration, as shown in FIG. 2. The aperture 210 accommodates the non-connectorized portion 235 and prevents the non-connectorized portion 235 from snagging on the bulkhead 230. In some embodiments, the aperture 210 is configured to allow the non-connectorized portion 235 to slide back and forth in the aperture 210 without snagging.

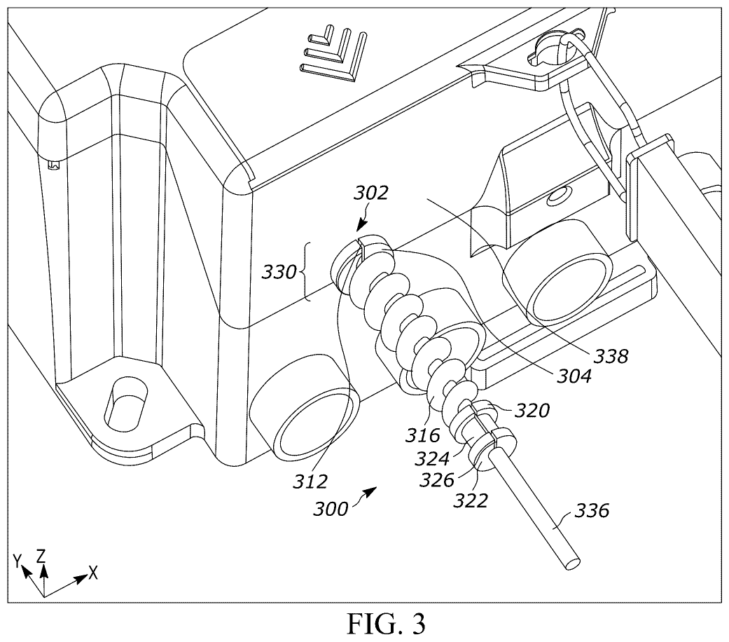

FIG. 3 shows a strain relief grommet 300, having a cable 336 placed therein, inserted into a bulkhead 330 of an enclosure 338 (e.g., a pcb enclosure, a battery box, a power tool housing, etc.). The cable 336 may include a connector (not shown). The cable 336 may be inserted into the grommet 302 of the strain relief grommet 300. The grommet 302 may be inserted into the bulkhead 330 as described above. In some embodiments, the enclosure 337 is divided into two halves (not shown) that come together to from the bulkhead 330. In such embodiments, the cable 336 may be inserted into the strain relief grommet 300, and the two halves of the electrical enclosure 338 may be closed over a groove portion 208, 324 of the grommet 302. In such cases, the inner wall abutting portion 204 and the outer wall abutting portion 306 of the grommet 302 cause the grommet 302 to be retained in the bulkhead 330 as described above. In some embodiments, the two halves of the electrical enclosure are closed over the groove portion 208, and a cable movement restraining element (not shown) is close or tightened onto groove portion 324 to prevent or restrict the cable 336 from being pushed or pulled through the inner aperture of the strain relief grommet 300. For example, a wire tie or clip may be secured onto groove portion 324, after a cable is run therethrough, to prevent or restrict the cable 336 from being pushed or pulled and further through the inner aperture of the strain relief grommet 300.

The grommet 302 may be configured to seal off a flow of fluid from passing through the bulkhead 330. The inner wall abutting portion 304 or the outer wall abutting portion 306 may be configured to create a fluid-tight seal against the inner wall surface 232 or the outer wall surface 234. In some embodiments, the groove portion 308 is configured to form a fluid-tight seal against an inner rim (not shown) of the bulkhead 330. In such embodiments, a fastener (e.g., a wire tie, a bolt, a snap, etc.) may be used the fasten the two halves of the enclosure 338 together, to ensure that a fluid-tight seal is maintained between the groove portion 308 and the inner rim of the bulkhead 330.

Various features and advantages of the disclosure are set forth in the following claims.

What is claimed is:

1. A strain relief grommet comprising:
a bulkhead grommet including
an inner wall abutting portion,
an outer wall abutting portion,
a groove portion having an axial portion extending between the inner wall abutting portion and the outer wall abutting portion, and
a grommet inner aperture extending through the axial portion of the groove portion; and
a strain relief feature connected to the bulkhead grommet.

2. The strain relief grommet of claim 1, wherein the inner wall abutting portion, the outer wall abutting portion, and the groove portion include a gap portion, wherein the gap portion is configured to allow a connectorized cable to be pressed through the gap portion from outside the bulkhead grommet into the grommet inner aperture.

3. The strain relief grommet of claim 1, wherein the bulkhead grommet is made of rubber.

4. The strain relief grommet of claim 2, wherein the strain relief feature is configured to have the connectorized cable inserted therethrough without disassembling the connectorized cable.

5. The strain relief grommet of claim 1, wherein the strain relief feature is spiral in shape.

6. The strain relief grommet of claim 1, wherein the bulkhead grommet is disposed at a first end of the strain relief feature, and wherein the strain relief grommet further includes a cable centering portion disposed at a second end of the strain relief feature.

7. The strain relief grommet of claim 6, wherein the cable centering portion includes
a cable centering portion inner aperture extending through an axial portion of the cable centering portion, and
a gap portion configured to allow a connectorized cable to also be pressed through the gap portion from outside the cable centering portion into the cable centering portion inner aperture.

8. An electrical enclosure comprising:
an enclosure housing including a bulkhead;
a bulkhead grommet installed in the bulkhead, the bulkhead grommet including
an inner wall abutting portion,
an outer wall abutting portion,
a groove portion having an axial portion extending between the inner wall abutting portion and the outer wall abutting portion, and
a grommet inner aperture extending through the axial portion of the groove portion;
a strain relief feature connected to the bulkhead grommet.

9. The electrical enclosure of claim 8, wherein the inner wall abutting portion, the outer wall abutting portion, and the groove portion include a gap portion, wherein the gap portion is configured to allow a connectorized cable to be pressed through the gap portion from outside the bulkhead grommet and into the grommet inner aperture.

10. The electrical enclosure of claim 8, wherein the bulkhead grommet is made of rubber.

11. The electrical enclosure of claim 9, wherein the strain relief feature is configured to have the connectorized cable inserted therethrough without disassembling the connectorized cable.

12. The electrical enclosure of claim 8, wherein the strain relief feature is spiral in shape.

13. The electrical enclosure of claim 8, wherein the bulkhead grommet is disposed at a first end of the strain relief feature, and wherein the strain relief feature further includes a cable centering portion disposed at a second end of the strain relief feature.

14. The electrical enclosure of claim 13, wherein the inner wall abutting portion, the outer wall abutting portion, and the groove portion include a gap portion, wherein the gap portion is configured to allow a connectorized cable to be pressed through the gap portion from outside the bulkhead grommet into the grommet inner aperture.

15. A method of installing a strain relief grommet comprising:
pressing a cable through a gap portion of in a bulkhead grommet of a strain relief grommet and into an inner aperture of the bulkhead grommet; and
guiding the cable through a strain relief feature of the strain relief grommet.

16. The method of claim 15, wherein the cable is a connectorized cable,
wherein pressing the cable through the gap portion in the bulkhead grommet includes pressing a non-connectorized portion of a connectorized cable through the gap portion in the bulkhead grommet and into an inner aperture of the bulkhead grommet; and
wherein guiding the cable through the strain relief feature of the strain relief grommet includes guiding the non-connectorized portion through the strain relief feature of the strain relief grommet.

17. The method of claim 15, wherein the bulkhead grommet includes
an inner wall abutting portion,
an outer wall abutting portion,
a groove portion having an axial portion extending between the inner wall abutting portion and the outer wall abutting portion, and
a grommet inner aperture extending through the axial portion of the groove portion.

18. The method of claim 17, further including inserting the bulkhead grommet into a bulkhead, thereby causing the inner wall abutting portion to flex, until the inner wall abutting potion returns to an unflexed shape and abuts an inner wall surface of the bulkhead.

19. The method of claim 18, wherein the groove portion forms a fluid-tight seal against an inner rim of the bulkhead.

20. The method of claim 17, wherein the bulkhead grommet is made of plastic.
